(19) United States
(12) Patent Application Publication
(10) Pub. No.: US 2013/0050259 A1
(43) Pub. Date: Feb. 28, 2013

(54) APPARATUS AND METHOD FOR SHARING DATA USING AUGMENTED REALITY (AR)

(71) Applicants: Kye-Hyuk AHN, Bucheon-si (KR); Won-Tae KIM, Seoul (KR)

(72) Inventors: Kye-Hyuk AHN, Bucheon-si (KR); Won-Tae KIM, Seoul (KR)

(73) Assignee: PANTECH CO., LTD., Seoul (KR)

(21) Appl. No.: 13/563,726

(22) Filed: Jul. 31, 2012

(30) Foreign Application Priority Data
Aug. 31, 2011 (KR) 10-2011-0087985

(51) Int. Cl. G09G 5/00

(52) U.S. Cl. 345/633

(57) ABSTRACT

A first terminal, includes: an image acquiring unit to acquire an image of a second terminal; a controller to control the first terminal and to acquire network information from the image of the second terminal; an AR configuration unit to create an AR display based on the image of the second terminal and the acquired network information; and a communication unit to communicate data between the first terminal and the second terminal via a network. A method, includes: acquiring an image of a second terminal; acquiring network information of a network from the image of the second terminal; creating an AR display based on the image of the second terminal and the acquired network information; allowing a selection of data based on the AR display; and communicating the selected data between the terminal and the second terminal via the network.

### CROSS-REFERENCE TO RELATED APPLICATION

This application claims from and the benefit under 35 U.S.C. §119(a) of a Korean Patent Application No. 10-2011-0087985, filed on Aug. 31, 2011, which is incorporated by reference for all purposes as if fully set forth herein.

### BACKGROUND

1. Field

Exemplary embodiments of the present invention relate to a technique for data sharing between terminals, and more particularly, to an apparatus and method for sharing data to allow a terminal's user to receive and transfer data with another terminal using augmented reality (AR).

2. Discussion of the Background

A terminal may share data with other terminals using remote data sharing through a mail address or a cloud address. A terminal that uses remote data sharing may connect to an address of an external network, which is also accessed by another terminal to retrieve data stored in correlation with the address. Data sharing may also been performed using a local network. A terminal may share data with another terminal using the data sharing through the local network. In order to perform this data sharing, the terminal may search for another terminal, and establish a local network with the found terminal, in order to share data. Thus, in the sharing described above, a non-automated technique may exist for a user of a terminal if the user desires to share data with another terminal.

### SUMMARY

Exemplary embodiments of the present invention provide an apparatus and method for sharing data using augmented reality (AR), which may include using information acquired from a terminal in an active mode or capturing an image of a terminal in a passive mode.

Additional features of the invention will be set forth in the description which follows, and in part will be apparent from the description, or may be learned by practice of the invention.

An exemplary embodiment of the present invention discloses a first terminal to provide augmented reality (AR) to share data, including: an image acquiring unit to acquire an image of a second terminal; a controller to control the first terminal and to acquire network information from the image of the second terminal; an AR configuration unit to create an AR display based on the image of the second terminal and the acquired network information; and a communication unit to communicate data between the first terminal and the second terminal via a network, wherein the communication unit communicates data selected via the AR display.

An exemplary embodiment of the present invention discloses a method for sharing data via augmented reality (AR) on a first terminal, including: acquiring an image of a second terminal; acquiring network information of a network from the image of the second terminal; creating an AR display based on the image of the second terminal and the acquired network information; allowing a selection of data based on the AR display; and communicating the selected data between the terminal and the second terminal via the network.

An exemplary embodiment of the present invention discloses a passive-mode terminal, comprising: a display unit to display an image comprising network information; a quick response (QR) code generating unit to generate a QR code to identify the terminal; a frame marker generating unit to generate a frame marker of a WiFi direct network to which the terminal is a member; and a communication unit to communicate data between the passive-mode terminal and an active-mode terminal via a network, wherein the network corresponds to the WiFi direct network or a WiFi direct network to which the active-mode terminal is a member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a data sharing system according to an exemplary embodiment of the present invention.

FIG. 2A illustrates a passive-mode terminal display according to an exemplary embodiment of the present invention.

FIG. 2B illustrates a passive-mode terminal display according to an exemplary embodiment of the present invention.

FIG. 3A illustrates an active-mode terminal according to an exemplary embodiment of the present invention.

FIG. 3B illustrates an active-mode terminal according to an exemplary embodiment of the present invention.

FIG. 4 is a view illustrating a connection process for data sharing when terminals A and B are connected to the same WiFi direct network according to an exemplary embodiment of the present invention.

FIG. 5 is a view illustrating a connection process for data sharing when both terminals A and B are initially not connected to a WiFi direct network according to an exemplary embodiment of the present invention.

FIG. 6 is a view for illustrating an “INVITE” process according to an exemplary embodiment of the present invention.

FIG. 7 is a view for illustrating a “VISIT” process according to an exemplary embodiment of the present invention.

FIG. 8 is a flowchart illustrating a method for sharing data according to an exemplary embodiment of the present invention.

FIG. 9 is a flowchart illustrating a method for receiving data lists from another terminal according to an exemplary embodiment of the present invention.

FIG. 10 is a flowchart illustrating a method for receiving data lists according to an exemplary embodiment of the present invention.

FIG. 11 is flowchart illustrating a data transfer process according to an exemplary embodiment of the present invention.

FIG. 12 is a flowchart illustrating a data fetch process according to an exemplary embodiment of the present invention.

FIG. 13 is a flowchart illustrating a method for controlling a terminal to transfer data to another terminal according to an exemplary embodiment of the present invention.

FIG. 14 is a diagram illustrating a data sharing apparatus according to an exemplary embodiment of the present invention.

FIG. 15 is a flowchart illustrating a method for sharing data according to an exemplary embodiment of the present invention.

FIG. 16 illustrates Augmented Reality (AR) displays according to an exemplary embodiment of the present invention.

FIG. 17 illustrates Augmented Reality (AR) displays according to an exemplary embodiment of the present invention.

FIG. 18 illustrates Augmented Reality (AR) displays according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

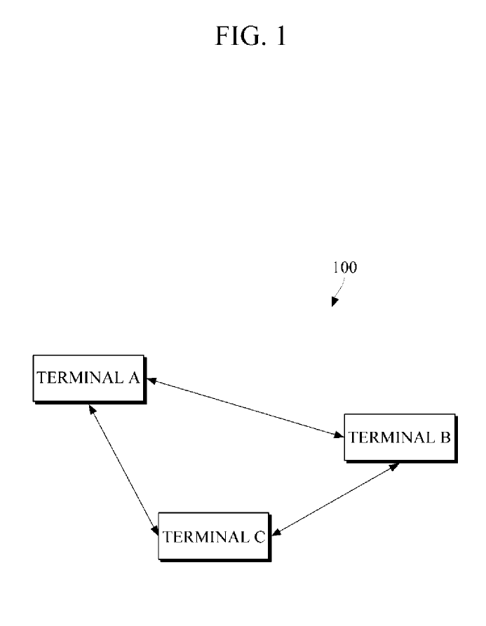

FIG. 1 is a diagram illustrating a data sharing system according to an exemplary embodiment of the present invention.

Referring to FIG. 1, the data sharing system 100 includes terminal A, terminal B, and terminal C. The terminals establish a local network, and may share data through a local network. The data may be text, still images, audio data, moving images, multimedia data, metadata for data, and the like. The data may be shared as files or folders containing multiple files.

The terminals may be portable electronic devices or non-portable devices, such as a personal computer, a set-top box, a lap-top computer, a mobile phone, a smart phone, a Personal Digital Assistant (PDA), a Portable Multimedia Player (PMP), a MP3 (MPEG-3) player, and the like. Any number equal to or greater than 2 may be implemented as the number of terminals for data sharing.

The local network allows connections for data transmission and reception between various terminals connected via a network. An example of a local network may be a WiFi direct network. The WiFi direct is an enhanced technology, versus a conventional WiFi technique. The conventional WiFi technique allocates an IP address using a wireless Access Point (AP) to establish a network, while the WiFi direct network allows terminals to connect to each other without using a AP. In various examples disclosed herein, the terminals may be connected to each other via a WiFi direct network.

The terminals A, B, and C may each have a Service Set IDentifiers (SSIDs) in order to establish a WiFi direct network. The terminals A, B, and C are allocated an individual SSID to send and receive connection requests to and from the WiFi direct network. The terminals A, B, and C may use their SSID to perform session connections for data sharing, before they establish a connection via the WiFi direct network.

The terminals A, B, and C, if connected via the WiFi direct network, become members of the WiFi direct network, and a representative member of the WiFi direct network may be referred to as a group owner. The group owner has a group owner ID GroupOwnerID to distinguish the network from other networks. The assignment of the GroupOwnerID may be created and assigned based on a standard. The group owner ID may be created by adding a prefix to the SSID of the terminal to be the group owner, for example, in the form of “Direct_[xx][SSID]”, wherein [xx] is a random 2 byte character, and [SSID] is a SSID of the group owner.

For example, if a terminal whose SSID is “Pantech” is selected as a group owner, the terminal may have a group owner ID “Direct_zePantech”, wherein ze is a randomly selected. A terminal is not allocated an IP address until it is connected to the WiFi direct network, and a group owner allocates IP addresses as identifiers to terminals belonging to the WiFi direct network. If a WiFi direct network is established, or a new terminal is added to the WiFi direct network, a setting may be set to determine whether to change the group owner to a more suitable terminal or maintain a specific terminal as a fixed group owner. If a variable group owner is implemented, and if a new terminal is added to a WiFi direct network (and hence establishing membership in the WiFi direct network), a group owner may be selected from among the terminals that are part of the WiFi direct network.

After a WiFi direct network is established, the SSID of all members belonging to the WiFi direct network are no longer searched, and only a group owner ID is used to find or recognize the WiFi direct network. A terminal that requests to register as a new member in the WiFi direct network requests a network connection using a group owner ID of the WiFi direct network as an identifier.

A technique of adding a new member to a network after the network is established may occur in two cases: one is the case where a member connected to a network invites a terminal not belonging to the network, and the other is the case where a terminal not belonging to a network visits the network. The case where a member connected to a network requests an invitation of a terminal not belonging to the network is called “INVITE”, and the case where a terminal that does not belong to a network and connects to the network using its own SSID as an identifier is called “VISIT”. In the case of INVITE, a terminal connected to a network uses a SSID of another terminal not belonging to the network as an identifier to request a connection of the other terminal to the network. In the case of VISIT, a terminal having a SSID uses a group owner ID as an identifier of a network to which the terminal requests a connection and may request a connection to the network.

In the case where a group owner disconnects from a network, all members belonging to the corresponding group are disconnected from the network as well. If a non-group owner disconnects from a network, the corresponding member is disconnected from the network as well.

The terminals A, B, and C may operate in either an active mode or in a passive mode. The active mode allows a terminal to connect to other terminals. A terminal that has entered the active mode may photograph another terminal if photographing is activated, analyze the photographed image, extract connection information about the other terminal, and attempt to connect to the other terminal based on the extracted information. Once connected, the terminals may share data. The passive mode displays connection information used for allowing another terminal in active mode to connect to the terminal. In the following description, a terminal which operates in the active mode is referred to as an active-mode terminal, and a terminal which operates in the passive mode is referred to as a passive-mode terminal.

If any of terminals A, B, or C are in the passive mode, the passive-mode terminal A, B, or C displays an information code, which may include connection information used to connect to a local network such as a WiFi direct network. The information code may be a Quick Response (QR) code, a bar code, etc. Hereinafter, for convenience of description, it is assumed that the information code is a QR code.

If any of terminals A, B, or C are in an active mode, the active-mode terminal A, B, or C allows the photographing of a passive-mode terminal, and extracts connection information of the passive-mode terminal from the photograph of the passive-mode terminal. Specifically, this information may be obtained from an information code displayed on the passive-mode terminal. Afterwards, due to the obtained information, the active-mode terminal and the passive-mode terminal may interface and connect, thereby allowing for the sharing of data.

If an active-mode terminal and a passive-mode terminal are connected to the same WiFi direct network, they establish a communication interface session to allow data sharing. The communication interface session for data sharing may incorporate several different interfaces, such as an interface A and an interface B. Interface A is a data connection interface that may be displayed on an active-mode terminal. Interface A may include a message that represents a connection from an active-mode terminal to a passive-mode terminal. The interface A may be displayed as long as a data sharing application is being executed, and is not terminated. Accordingly, even if a data sharing application is executed in the background or conversion from the active mode to the passive mode occurs while data is being transferred, a terminal may receive notification via interface A indicating the result of the data transmission.

Conversely, a passive-mode terminal may display interface B after a connection is made from an active-mode terminal to a passive-mode terminal. Interface B may be displayed if the two terminals are transmitting data between each other. After the transmission is completed, interface B may be exited.

Each of terminals A, B, or C may transition from the active mode to the passive mode or from the passive mode to the active mode based on a satisfied condition or stimulus, such as a user input. For example, a user may assert a mode conversion button or select a mode conversion menu on a display.

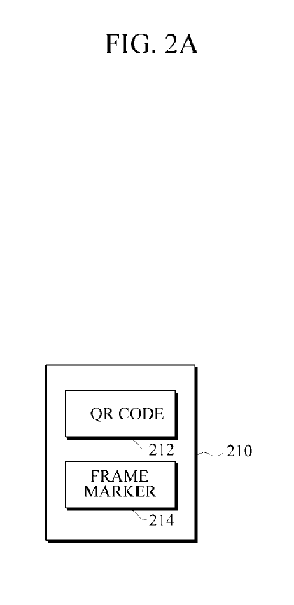

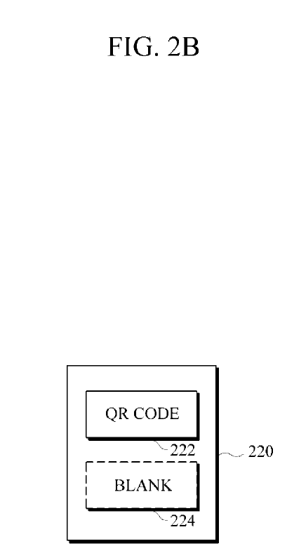

FIG. 2A illustrates a passive-mode terminal display according to an exemplary embodiment of the present invention. FIG. 2B illustrates a passive-mode terminal display according to an exemplary embodiment of the present invention.

Referring to FIG. 2A, an initial display 210 of a passive-mode terminal includes a QR code area 212 and a frame marker area 214. The QR code area 212 contains a QR code, which may be created in real time, and serve to contain information for establishing a WiFi direct network.

The QR code may be provided by an application of a terminal in passive mode, regardless of whether the terminal is connected to a WiFi direct network. In the case where the passive-mode terminal is not connected to a WiFi direct network, the QR code may include SSID information. As stated above, the SSID information may be used for connecting to a WiFi direct network. If the passive-mode terminal is connected to a WiFi direct network, the passive-mode terminal may create and display a QR code including ID information of a group owner, and may additionally include ID address information allocated by the group owner. Accordingly, an active-mode terminal reads the QR code of the passive-mode terminal, thereby determining whether the passive-mode terminal is connected to a WiFi direct network.

As described above, if a group owner changes, the changed group owner requests members belonging to the corresponding WiFi direct network to create a new QR code that includes an ID of the new group owner. The new QR code may be displayed on a terminal while in a passive mode. If a fixed group owner is used, the process of creating and displaying a new QR code may not be implemented.

Referring again to FIG. 2A, the frame marker area 214 displays a frame marker mapped to an allocated IP address assigned if the passive-mode terminal connects to the WiFi direct network. The information associated with the frame marker is used to augment a user interface (UI) on an active-mode terminal, if the active-mode terminal communicates with the passive-mode terminal in the form of Augmented Reality (AR). For example, the information associated with the frame marker may be used to identify a party to whom data will be transferred.

The passive-mode terminal may be allocated a unique frame marker mapped to an allocated IP address with reference to a frame marker table, after the passive-mode terminal is connected to the WiFi direct network. The frame marker of the frame marker area 214 is photographed by an active-mode terminal, and then augmented and displayed on an image of the passive-mode terminal.

The frame marker table, which contains a correlation between an ID address and a frame marker, may be created in advance in each of the terminals A, B, or C. Or, alternatively, each of the terminals A, B, and C may receive a frame marker table via a communication technique. An example of the frame marker table is shown in Table 1 below.

TABLE 1

| Frame Marker ID | IP Address |
|---|---|
| 1 | xxx.xxx.xxx.1 |
| 2 | xxx.xxx.xxx.2 |
| . . . | . . . |
| 511 | xxx.xxx.xxx.511 |

The frame marker table includes 512 frame markers that are distinguished by IDs 0 through 511, and each frame marker may be mapped to an IP address whose tail part is identical to the frame marker's ID. In the case where a frame marker table, as shown in Table 1 is provided, an active-mode terminal may determine an IP address of a passive-mode terminal based on a frame marker ID acquired from a photograph of the passive-mode terminal.

FIG. 2A illustrates an example of a display 220 of a passive-mode terminal not connected to a WiFi direct network. A QR code area 222 includes a SSID. The passive-mode terminal is not yet allocated an IP address from a group owner since the passive-mode terminal is connected to no WiFi direct network. Accordingly, a frame marker area 224 does not display any frame marker or IP information.

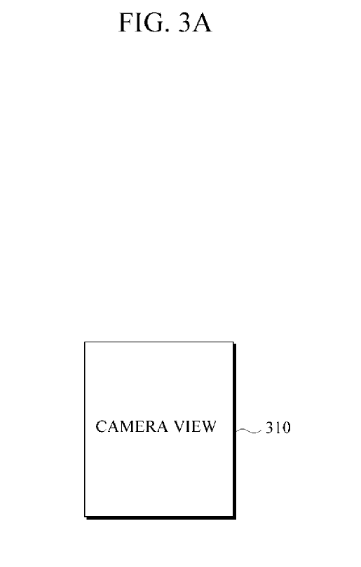

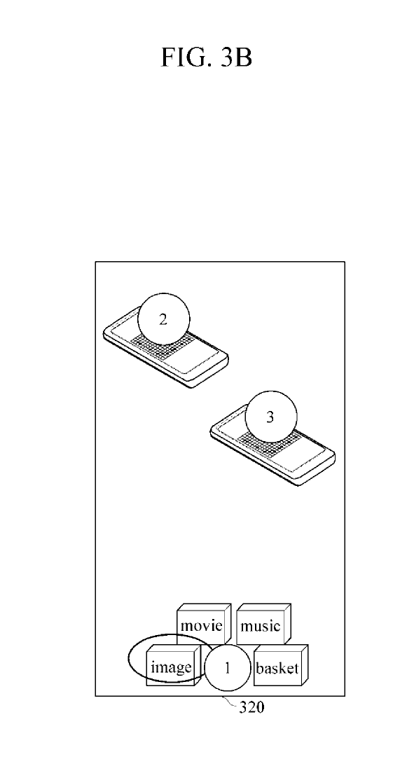

FIG. 3A illustrates an active-mode terminal according to an exemplary embodiment of the present invention. FIG. 3B illustrates an active-mode terminal according to an exemplary embodiment of the present invention.

As illustrated in FIG. 3A, the active-mode terminal provides a camera view 310 that displays an image captured by a camera. For example, this image may contain at least one passive-mode terminal.

FIG. 3B shows an example of a screen 320 when the active-mode terminal photographs two passive-mode terminals.

A terminal A is in an active mode, and terminals B and C are in a passive mode. A frame marker of terminal A is “1”, the frame marker of terminal B is “2”, and the frame marker of terminal C is “3”. If terminal A photographs terminals B and C, terminal A may create and display an AR display, as illustrated in FIG. 3B.

As shown by display 320, which contains a captured image, the frame marker “2” is displayed as AR information associated with terminal B, and the frame marker “3” is displayed as AR information associated with terminal C. Also, information (for example, image, movie, music, etc.) based on the types of data available and transferable by terminal A may be displayed around the frame marker “1” (which corresponds to the frame marker of terminal A) in the active mode. In addition, terminal A may display a folder “basket” containing data that is to be transferred.

In this disclosure, four situations in which terminals connect to each other and share data are covered: 1) where both terminals A and B are connected to the same WiFi direct network; 2) where neither of terminals A and B are connected to a WiFi direct network; 3) where the terminal A is connected to a WiFi direct network while the terminal B is not connected to a WiFi direct network; and 4) where the terminals A and B are connected to different WiFi direct networks.

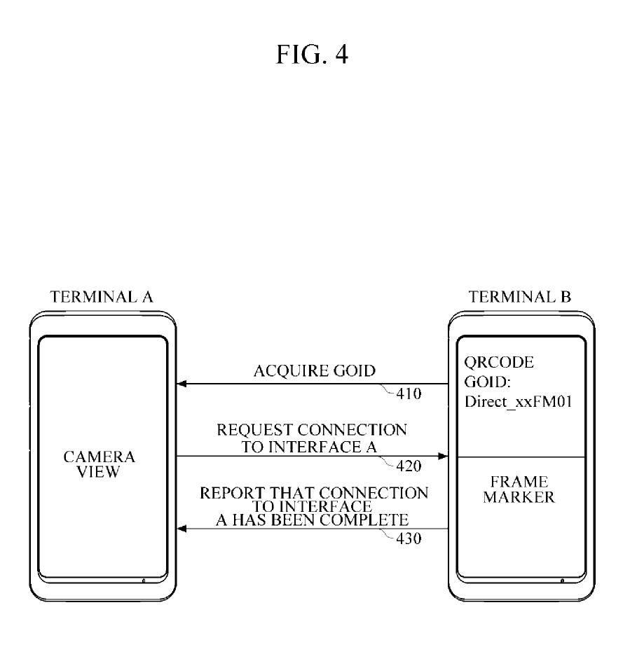

FIG. 4 is a view illustrating a connection process for data sharing when terminals A and B are connected to the same WiFi direct network according to an exemplary embodiment of the present invention.

Both terminals A and B are connected to a WiFi direct network having the same group owner ID (hereinafter, referred to as a GOID). Referring to FIG. 4, terminals A and B are allocated Direct_xxFM01 as the GOID. Terminal B, which is a passive-mode terminal, displays a QR code including a GOID and a frame marker that is identification information of the WiFi direct network. In FIG. 4, for convenience of description, “GOID:Direct_xxFM01” is displayed as text, and not an actual QR code on terminal 3.

Terminal A, which is an active-mode terminal, scans the QR code of terminal B to acquire the GOID (410). Thus, terminal A may confirm that terminal B has the same GOID and is a group member of the same WiFi direct network in which the terminal A belongs. In this case, terminal A requests terminal B to connect to an interface A (420), and once terminal B connects to the interface A in response to the request from the terminal A, reports to terminal A that a connection to the interface A has been complete (430). As both terminal A and B are part of the same Wifi direct network, a connection may be made without configuring a network connection,

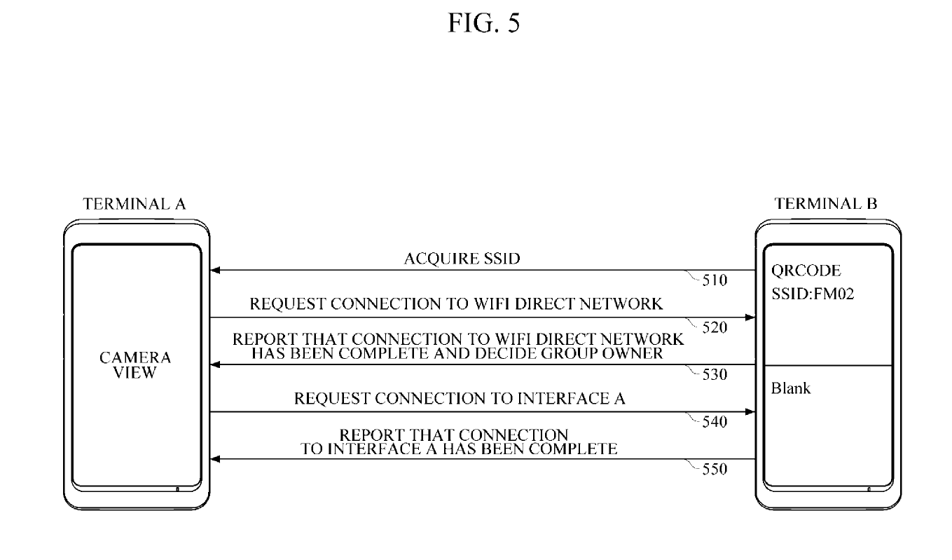

FIG. 5 is a view illustrating a connection process for data sharing when both terminals A and B are initially not connected as a WiFi direct network according to an exemplary embodiment of the present invention.

Referring to FIG. 5, a SSID of terminal A is “FM01” and a SSID of terminal B is “FM02”. Terminal B, which is in a passive mode, creates a QR code that includes and displays information “FM02” as a QR code. Terminal A, which is in an active mode, scans the QR code of terminal B to acquire a SSID of terminal B (510).

Terminal A requests terminal B to connect to the WiFi direct network using the SSID of the terminal B (520), and terminal B connects to the WiFi direct network along with the terminal A, in response to the request from terminal A (530). At this time, a group owner between terminals A and B is decided. In FIG. 5, terminal A becomes the group owner.

Terminal A requests terminal B to connect to an interface A, and terminal B connects to the interface A with terminal A and reports to terminal A that a connection to the interface A has been complete (550).

If the passive-mode terminal B is connected to the WiFi direct network, the passive-mode terminal B creates a new QR code including a GOID (Direct_xxFM01) of the WiFi direct network, and displays the new QR code on the display. If terminal A is converted to a passive mode, the terminal A creates a QR code including the GOID of the WiFi direct network and displays the QR code on the display.

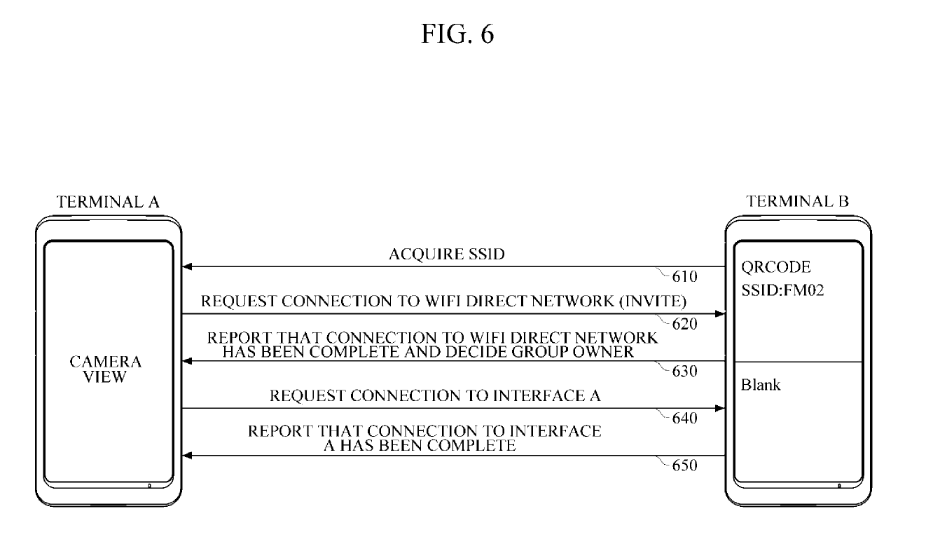

FIG. 6 is a view for illustrating an “INVITE” process according to an exemplary embodiment of the present invention.

Referring to FIG. 6, terminal A is connected to the WiFi direct network and has a GOID “Direct_xxFM01”. Also, terminal B is not connected to a WiFi direct network, and creates a QR code indicating that a SSID is “FM02” and displays the QR code on a display if terminal B is in a passive mode.

Terminal A, which is in an active mode, scans the QR code of terminal B to acquire the SSID of terminal B (610).

Terminal A requests terminal B to connect to the WiFi direct network using the SSID of the terminal B (620). A process in which a terminal connected to a WiFi direct network requests another terminal not connected to a WiFi direct network to connect to the WiFi direct network is called “INVITE”.

Terminal B connects to the WiFi direct network in response to the request from terminal A (630). At this time, a group owner between the terminals A and B is determined. Referring to FIG. 6, the group owner is determined to be terminal A.

Terminal A requests terminal B to connect to an interface A (640), and terminal B connects to the interface A with the terminal A, and reports that a connection to the interface A has been complete (650).

If terminal B, which is in a passive mode, is connected to the WiFi direct network, terminal B creates a new QR code including a GOID (Direct_xxFM01) of the WiFi direct network and displays the QR code on a display.

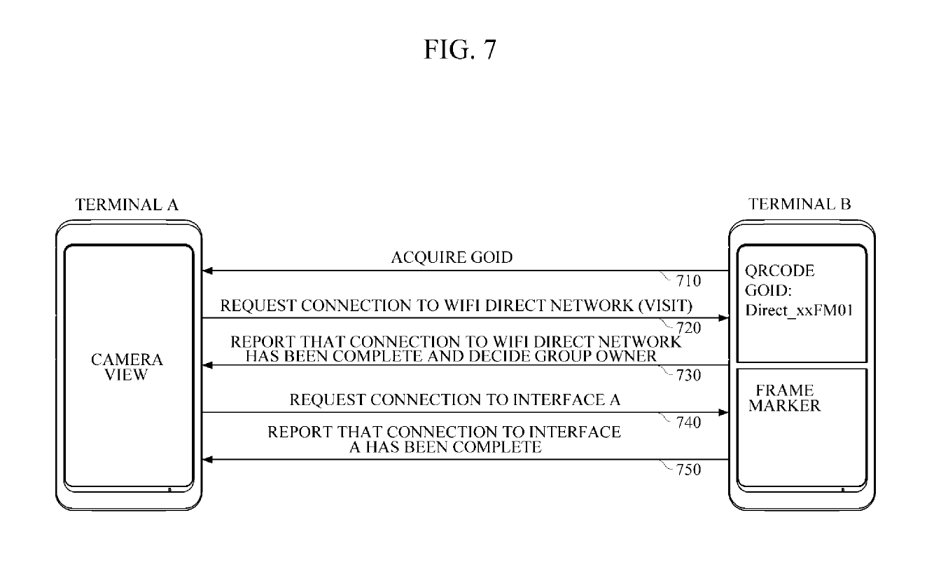

FIG. 7 is a view for illustrating a “VISIT” process according to an exemplary embodiment of the present invention.

Terminal B is connected to a WiFi direct network having a GOID “Direct_xxFM01”, and displays a QR code including the GOID and a frame marker according to an allocated IP address.

Terminal A, which is in an active mode, scans the QR code of the terminal B to acquire the GOID (710). Terminal A requests terminal B to connect the terminal A to the WiFi direct network using the GOID (720). As such, a process in which a terminal is not connected to a WiFi direct network, and requests to another terminal connected to a WiFi direct network so that the terminal may participate in the WiFi direct network, is called “VISIT”.

Terminal B connects to the WiFi direct network along with the terminal A (730). If the GOID is variable, a new group owner may be selected. In the example of FIG. 7, the GOID does not change even though terminal A connects to the WiFi direct network.

Terminal A requests terminal B to connect to an interface A (740), and terminal B connects to the interface A with terminal A, and reports that a connection to the interface A has been completed (750).

If terminal A, which is in an active mode, transitions to a passive mode, terminal A creates a new QR code including a GOID (Direct_xxFM01) of the WiFi direct network and displays the new QR code on a display.

If terminals A and B are all connected to a WiFi direct network but have different GOIDs, the terminals A and B are determined to be connected to different WiFi networks. In this case, although terminal A, which is in an active mode, scans a QR code of terminal B to acquire a GOID of the terminal B, terminal A does not request terminal B to connect to the WiFi direct network since terminals A and B have different GOIDs and are connected to different WiFi direct networks. Thus, data sharing between members belonging to different groups of WiFi direct networks may not be permitted.

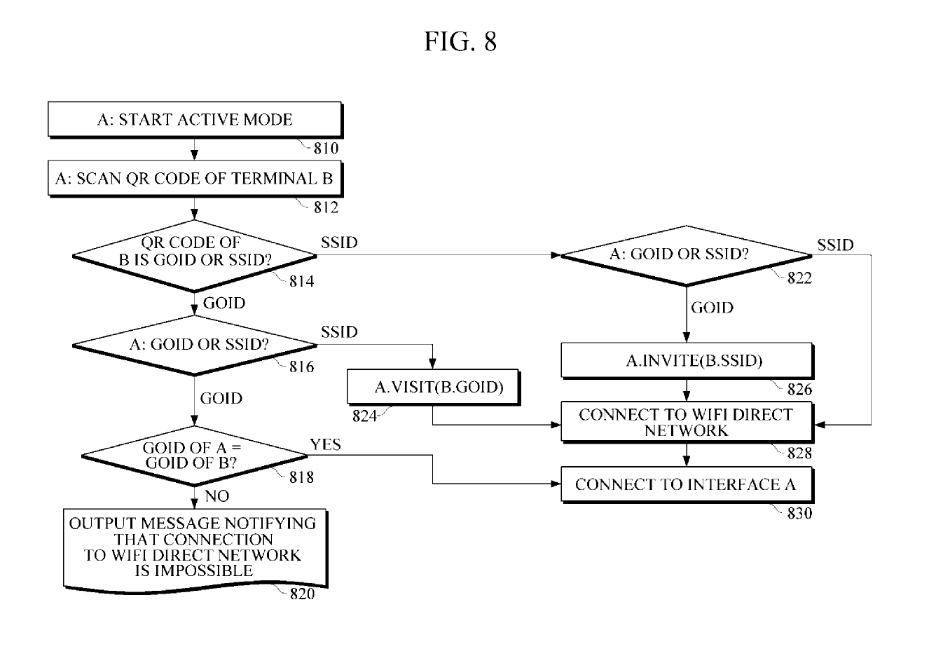

FIG. 8 is a flowchart illustrating a method for sharing data according to an exemplary embodiment of the present invention.

Referring to FIG. 8, ‘A:’ represents actions performed by terminal A, and ‘B:’ represents actions performed by terminal B. Terminal A begins to operate in an active mode (810). Terminal A scans a QR code of terminal B to acquire connection information for a connection to a WiFi direct network from the QR code (812). Terminal A determines whether the connection information included in the QR code is a GOID or a SSID (814). If terminal A has acquired a GOID of terminal B from the QR code, terminal A determines whether its own connection information is a GOID or a SSID (either a group owner of a WiFi direct network or a member of a WiFi direct network) (816).

If terminal A has a GOID (816), terminal A determines whether the GOID is identical to the GOID of terminal B (818). If the GOID of terminal A is identical to the GOID of terminal B, terminals A and B establish an interface A for data sharing, as described above with reference to FIG. 4 (830). If the GOID of terminal A is different from the GOID of terminal B, terminal A determines that terminal B is not connected to the WiFi direct network, and accordingly may send a message notifying that a connection to the WiFi direct network is not possible at this time.

If terminal A acquires a GOID from the QR code of terminal B and terminal A has a SSID (816), terminal A performs a “VISIT” using the GOID of terminal B, which has been described above with reference to FIG. 7. That is, terminal A may connect to the WiFi direct network in which terminal B belongs (828), and establish an interface A with the terminal B (830).

If terminal A has acquired a SSID from the QR code of terminal B, terminal A determines if is a group owner or a member, by determining if it has a GOID or a SSID (822). If terminal A has a SSID, the terminals A and B are connected to a WiFi direct network (828), as described above with reference to FIG. 5, since both the terminals A and B are not connected to a WiFi direct network, and establishes an interface A (830).

If terminal A has acquired a SSID from the QR code of terminal B (814) and has a GOID (816), terminal A performs an “INVITE” process using the SSID of terminal B, and allows terminal B to connect to a WiFi direct network of terminal A (828), and establishes an interface A (830). Terminals A and B are connected to the WiFi direct network (828), the automatic connection process is complete if the corresponding WiFi direct network uses a fixed group owner. If the WiFi direct network uses a variable group owner, a process of selecting a new group owner from among members belonging to the WiFi direct network may be performed. If a new group owner is determined, the new group owner broadcasts a new GOID to the members and requests the members to create new QR codes, thereby completing a connection to the WiFi direct network.

A protocol for data sharing between terminals will be disclosed below. The data sharing may be implemented along with a connection between two or more terminals.

1. Interface A

Table 2 is a table showing various parameters for a protocol for data sharing and establishing an interface A between at least two terminals.

| | | | | |
|---|---|---|---|---|
| 1 | 1 Byte | 4byte | 4byte | |
| | CONNECT_REO | myIP | toIP | |
| 2 | 1 Byte | 4byte | 4byte | |
| | CONNECT_RES | myIP | [SUCCESS\|FAIL\|ALREADY] | |
| 3 | 1 Byte | 4byte | 4byte | |
| | DiSCONNECT_REO | myIP | toIP | |
| 4 | 1 Byte | 4byte | 4byte | |
| | DISCONNECT_RES | myIP | [SUCCESS\|FAIL\|ALREADY] | |
| 5 | 1 Byte | 4byte | 4byte | 256byte |
| | TRANSFER_REO | myIP | toIP | [contents_filename] |
| 6 | 1 Byte | 4byte | 4byte | |
| | TRANSFER_RES | myIP | [SUCCESS\|FAIL] | |
| 7 | 1 Byte | 4byte | 4byte | 256byte |
| | TRANSFER_CANCEL | myIP | toIP | [contents_filename] |
| 8 | 1 Byte | 4byte | 4byte | |
| | TRANSFER_CANCEL_RES | myIP | [SUCCESS\|FAIL] | |
| 9 | 1 Byte | 4byte | | |
| | TRANSFER_LIST_REO | myIP | | |
| 10 | 1 Byte | 4byte | 4byte | |
| | TRANSFER_LIST_RES | myIP | [SUCCESS\|FAIL\|EMPTY] | |
| 11 | 1 Byte | 4byte | 4byte | 4byte |
| | CONTENT_LIST_REO | myIP | [contents_type] | [count] |
| 12 | 1 Byte | 4byte | 4byte | 4byte |
| | CONTENT_LIST_RES | myIP | [count] | [SUCCESS\|FAIL\|EMPTY] |
| 13 | 1 Byte | 4byte | 4byte | 4byte |
| | CONTENT_LIST_MORE_REO | myIP | [contents_type] | [count] |
| 14 | 1 Byte | | | |
| | UPDATE_ORCODE | | | |

1-1) CONNECT_REQ: CONNECT_REQ is a message that requests another terminal to create an interface B. A terminal that receives the CONNECT_REQ message creates an interface B with a terminal that has transferred the CONNECT_REQ message, and requests a session connection to the terminal that has transferred the message. MyIP is an IP address of the terminal that transfers the message. ToIP is an IP address of the terminal to which the session connection is made.

1-2) CONNECT_RES: CONNECT_RES is a message that informs the terminal that has transferred the CONNECT_REQ message of the result of the connection request. MyIP is an address of the terminal which transfers the message. The result of the connection request is one of SUCCESS, FAIL, or ALREADY (which notifies that a session connection has been already made).

1-3) DISCONNECT_REQ: DISCONNECT_REQ is a message that requests another terminal to release the interface B, after the interface B has been established. A terminal that receives the DISCONNECT_REQ message removes the interface B with another terminal that has transferred the DISCONNECT_REQ message, and releases a session connection. MyIP is an IP address of the terminal that transfers the message. ToIP is an IP address of the terminal from which the session connection is released.

1-4) DISCONNECT_RES: DISCONNECT_RES is a message that informs the terminal that has transferred the DISCONNECT_REQ message the result of the disconnection request. MyIP is an IP address of the terminal that transfers the message. The result of the disconnection request is one of: FAIL and ALREADY (which notifies that the session connection has been already released)

1-5) TRANSFER_REQ: TRANSFER_REQ is a message that requests another terminal to transfer data. A terminal that receives the TRANSFER_REQ message transfers data such as, a file to another terminal that has requested transfer of data. The transfer of data may be done through an interface B. MyIP is an IP address of the terminal that transfers the message. ToIP is an IP address of the terminal to which the file is transferred. The ‘[contents_filename]’ is a file name of the data that is transferred.

1-6) TRANSFER_RES: TRANSFER_RES is a message that informs the terminal that has transferred the TRANSFER_REQ message of the result of the transfer request. MyIP is an IP address of the terminal which transfers the message. The result of the transfer request is one of SUCCESS or FAIL.

1-7) TRANSFER_CANCEL: TRANSFER_CANCEL is a message that cancels file transferring between two terminals. A terminal which receives the TRANSFER_CANCEL message cancels file transferring with another terminal that has transferred the TRANSFER_CANCEL message. MyIP is an IP address of the terminal that transfers the message. ToIP is an IP address of the terminal with which file transferring is cancelled. The ‘[contents_filename]’ is a file name of data that is subject to the transfer cancellation.

1-8) TRANSFER_CANCEL_RES: TRANSFER_CANCEL_RES is a message that informs the terminal that has transferred the TRANSFER_CANCEL_REQ message of the result of the transfer cancellation. MyIP is an IP address of the terminal which transfers the message. The result of the transfer cancellation may be one of SUCCESS or FAIL.

1-9) TRANSFER_LIST_REQ: TRANSFER_LIST_REQ is a message that requests data lists (or called content lists) that another terminal is transferring. The transfer of data may be done through the interface B. MyIP is an IP address of the terminal that transfers the message.

In this disclosure data lists may refer to a list or category of a type of data item, or may refer to individual or multiple items of data, and be used interchangeably with any term associated with data.

1-10) TRANSFER_LIST_RES: TRANSFER_LIST_RES is a message that informs the terminal that has transferred the TRANSFER_LIST_REQ of the result of the request. MyIP is an IP address of the terminal that transfers the message. The result of the request may be one of SUCCESS, FAIL, or EMPTY (which notifies that there is no list to be transferred).

1-11) CONTENT_LIST_REQ: CONTENT_LIST_REQ is a message that requests data lists of another terminal. The terminal transfers data lists from a first data item to a data item associated with [count]. The transfer of data may be done through the interface B. MyIP is an IP address of the terminal which transfers the message. The ‘[content_type]’ indicates a data type, such as picture, video, audio, etc. The ‘[count]’ indicates the number of items of a data list to be received.

1-12) CONTENT_LIST_RES: CONTENT_LIST_RES is a message that informs the terminal which has transferred the CONTENT_LIST_REQ message of the result of the request. MyIP is an IP address that transfers the message. The ‘[count]’ is a number associated with data that has been transferred. The result of the request may be one of SUCCESS, FAIL, or EMPTY (which notifies that there are no data lists).

1-13) CONTENT_LIST_MORE_REQ: CONTENT_LIST_MORE_REQ is a message that requests additional data lists other than data that has been previously transferred. A terminal that has received the message transfers the additional data lists. That is, the terminal transfers additional data that has not been transferred, such as data items after [count]. The transfer of data may be done through the interface B. MyIP is an IP address of the terminal that transfers the message. The ‘[content_type]’ indicate a data type that is to be received. The ‘[count]’ is the number of data items to be received.

1-14) UPDATE_QRCODE: a terminal that has received the UPDATE_QRCODE message checks its own GOID, SSID, and IP addresses, recreates a QR code, and displays the QR code on a display. The message is used to allow each terminal to display a QR code based on new information if a new member is added to a WiFi direct network and there is no fixed group owner, therefore causing a group owner to be changed.

2. Interface B

Table 3 is a description of a protocol for data sharing between terminals connected via Interface B.

TABLE 3

| | | | | | |
|---|---|---|---|---|---|
| 1 | 1byte | 4byte | 256byte | variable size | |
| | SEND_DATA | [length] | [contents_filename] | [data] | |
| 2 | 1byte | 256byte | | | |
| | SEND_DATA_ACK | [contents_filename] | | | |
| 3 | 1byte | 4byte | 4byte | 256byte | variable size |
| | SEND_CONTENT_LIST | [count] | [Length] | [contents_filename] | [display_data] |
| 4 | 1byte | 4byte | | | |
| | SEND_CONTENT_LIST_ACK | [count] | | | |
| 5 | 1byte | 4byte | 4byte | 4byte | 256byte |
| | SEND_TRANSFER_LIST | [count] | fromIP | toIP | [contents_filename] |
| 6 | 1byte | 4byte | | | |
| | SEND_TRANSFER_LIST_ACK | [count] | | | |

2-1) SEND_DATA: SEND_DATA is a message that transfers a file. Information about a terminal to which the file is to be transferred is included in a TRANSFER_REQ message of an interface A. The ‘[length]’ is the length of a packet to be transferred. The ‘[contents_filename]’ is the name of the file to be transferred. The ‘[data]’ is the data of the file that is to be transferred.

2-2) SEND_DATA_ACK: SEND_DATA_ACK is a message that notifies that data transmission according to the SEND_DATA message is complete. The ‘[contents_filename]’ is the name of the file that has been transferred.

2-3) SEND_CONTENT_LIST: SEND_CONTENT_LIST is a message transfers data lists to a terminal that has transferred the CONTENT_LIST_REQ message or the CONTENT_LIST_MORE_REQ message. The ‘[count]’ is the number of data lists that are transferred. The ‘[length]’ is the length of a packet for each data list. The ‘[contents_filename]’ is a file name included in each data list. The ‘[display_data]’ is a thumbnail image that will be shown for each data list. There may be a ‘[Length]’, ‘[contents_filename]’, ‘[display_data]’ for each ‘[count]’.

2-4) SEND_CONTENT_LIST_ACK: SEND_CONTENT_LIST_ACK is a message that notifies that transferring of data lists according to the SEND_CONTENT_LIST message is complete. The ‘[count]’ is the number of data items that have been completely transferred.

2-5) SEND_TRANSFER_LIST: SEND_TRANSFER_LIST is a message that transfers, through the interface B, the name of a file being transferred according to a SEND_DATA message and a list of IP addresses of terminals to which data will be transferred, to the terminal that has transferred the TRANSFER_LIST_REQ message through the interface A. The ‘[count]’ is the number of items that are transferred. FromIP is an IP address of a terminal that transfers data. ToIP is an IP address of a terminal that receives the data. The ‘[contents_filename]’ is the name of the file being transferred according to the SEND_DATA message.

2-6) SEND_TRANSFER_LIST_ACK: SEND_TRANSFER_LIST_ACK is a message that notifies that transferring of data according to a SEND_TRANSFER_LIST message is complete. The ‘[count]’ is the number of data lists that have been completely transferred.

In this disclosure, IFA represents that the interface A is used, and IFB represents that the interface B is used.

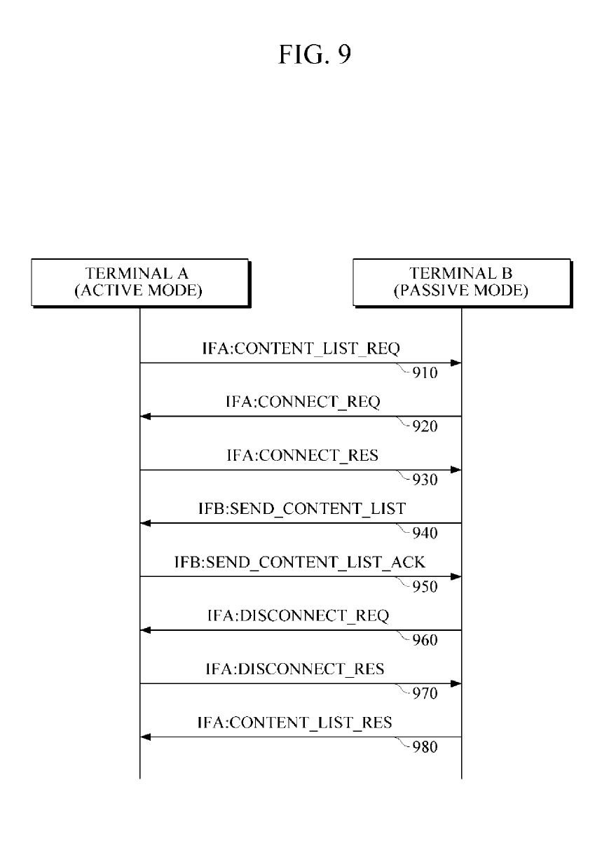

FIG. 9 is a flowchart illustrating a method for receiving data lists from another terminal according to an exemplary embodiment of the present invention.

Terminal A transfers a CONTENT_LIST_REQ message to terminal B to request terminal B 120 to transfer a data list (910). The CONTENT_LIST_REQ message may include an IP address of terminal A, a data type that the terminal A has requested to receive, and the number of data items or lists for terminal A to receive.

The terminal B transfers a CONNECT_REQ message for requesting the terminal A to connect the terminal B to the interface B (920). The CONNECT_REQ message may include an IP address of a terminal B, and an IP address of terminal A, to which terminal B makes a session connection.

Terminal A establishes the interface B with terminal B, and transfers a CONNECT_RES message to terminal B, thus responding to the request from terminal B (930). Terminal B makes a session connection through the interface B for data sharing with terminal A, and transfers a SEND_CONTENT_LIST message to terminal A to send data lists of terminal B to terminal A (940). Terminal A transfers a SEND_CONTENT_LIST_ACK message informing that data lists have been received, to terminal B (950).

Terminal B transfers a DISCONNECT_REQ message that requests terminal A to disconnect terminal B from the interface B, to terminal A (960). Terminal A disconnects terminal B from the interface B and transfers a DISCONNECT_RES message to terminal B (970). Terminal B transfers a CONTENT_LIST_RES message to terminal A to send data lists to terminal A in response to the data list request from the terminal A (980).

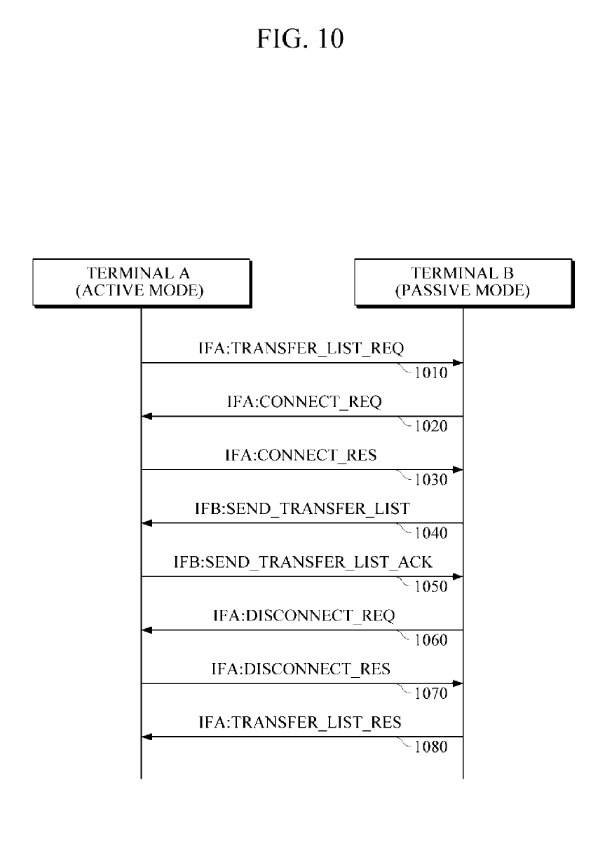

FIG. 10 is a flowchart illustrating a method for receiving data lists according to an exemplary embodiment of the present invention.

Terminal A transfers a TRANSFER_LIST_REQ message to terminal B to request terminal B to transfer data lists of data which terminal B has permitted to transfer and share to other terminals (1010). Terminal B transfers a CONNECT_REQ message to terminal A to request terminal A to make a session connection to terminal B through the interface B (1020). Terminal A transfers a CONNECT_RES message to terminal B in response to the CONNECT_REQ message (1030).

After the interface B allows terminal A and terminal B to be connected, terminal B transfers a SEND_TRANSFER_LIST message to terminal A to send the name of a file being transferred, and a list of IP addresses of the other terminals that receive the data being transferred (1040).

Terminal A transfers a SEND_TRANSFER_LIST_ACK message that notifies that transferring of data has been complete, to terminal B (1050).

After receiving the SEND_TRANSFER_LIST_ACK message, terminal B transfers a DISCONNECT_REQ message to terminal A to disconnect the interface B (1060), and terminal A transfers a DISCONNECT_RES message to terminal B (1070).

Terminal B transfers a TRANSFER_LIST_RES message to terminal A through the interface A to send data lists to terminal A (1080).

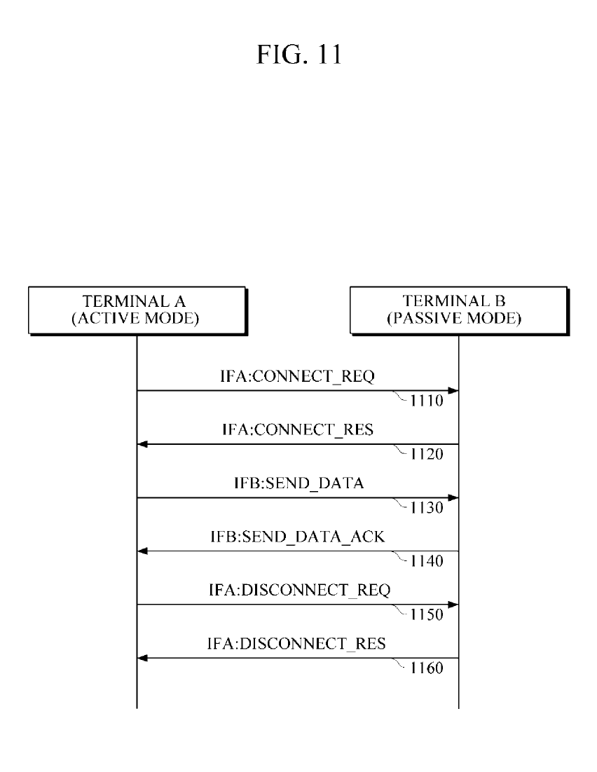

FIG. 11 is flowchart illustrating a data transfer process according to an exemplary embodiment of the present invention.

Terminal A transfers a CONNECT_REQ message to terminal B to request a session connection through the interface B (1110), and terminal B transfers a CONNECT_RES message to terminal A (1120). An interface B session for data sharing between the terminals A and B is established.

Terminal A transfers a SEND_DATA message to the terminal B, wherein the SEND_DATA includes data to be transmitted to terminal B (1130), and terminal B transfers a SEND_DATA_ACK message that notifies that transferring of data is complete, to terminal A (1140).

Terminal A transfers a DISCONNECT_REQ message that requests terminal B to release the interface B session, to terminal B (1150), and terminal B transfers a DISCONNECT_RES message, indicating the release request has been received and whether it has been released, to terminal A (1160).

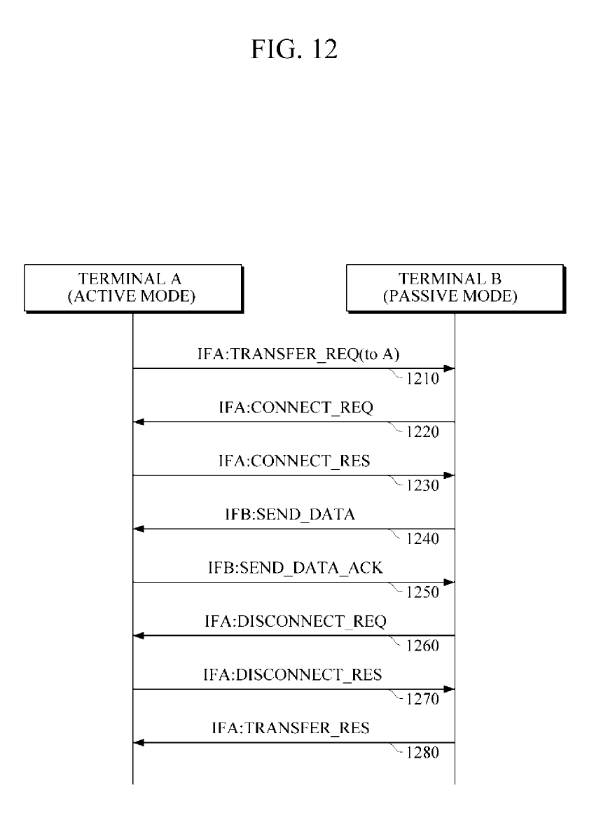

FIG. 12 is a flowchart illustrating a data fetch process according to an exemplary embodiment of the present invention.

The data fetch process may start according to a user input signal that is input by a user of an active mode terminal A. The user input signal allows a user to select data that is to be fetched from a terminal B from data lists received from the terminal B, and transmit the selected data to the terminal A.

Terminal A transfers a TRANSFER_REQ message to terminal B to request terminal B to transfer data to terminal A (1210).

Terminal B transfers a CONNECT_REQ message to terminal A to establish an interface B session with the terminal A (1220), and receives a CONNECT_RES message from terminal A (1230).

Terminal B transfers a SEND_DATA message to terminal A to transfer data to terminal A (1240). Terminal A transfers a SEND_DATA_ACK message notifying that transfer of data is complete, to terminal B (1250).

Terminal B transfers a DISCONNECT_REQ message to terminal A to disconnect the interface B session from terminal A (1260), and receives a DISCONNECT_RES message from terminal A (1270).

Terminal B transfers a TRANSFER_RES message to the terminal A through the interface A (1280).

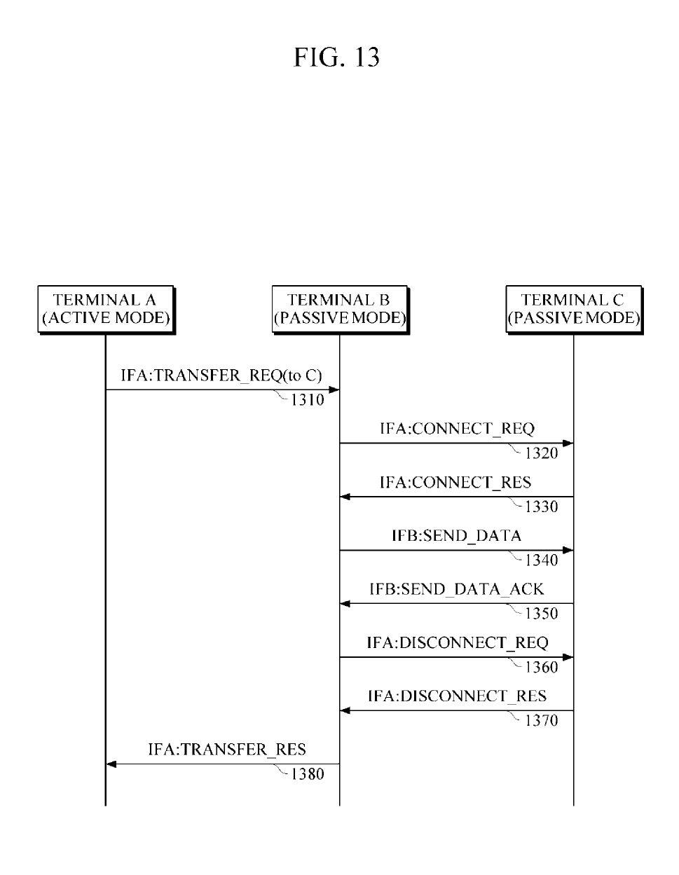

FIG. 13 is a flowchart illustrating a method for controlling a terminal to transfer data to another terminal according to an exemplary embodiment of the present invention.

Referring to FIG. 13, the active-mode terminal is terminal A, the first passive-mode terminal is terminal B, and the second passive-mode terminal is terminal C. Terminal A controls the passive-mode terminal B to transfer its own data to the passive-mode terminal C. The process illustrated in FIG. 13 may start according to a user input signal of the active-mode terminal A. The user input signal may allow a user to select data that is to be fetched from terminal B from data lists received from terminal B and transmit the selected data to terminal C.

Terminal A transfers a TRANSFER_REQ message that requests the transfer of data selected by the user, to terminal B (1310). Terminal B transfers a CONNECT_REQ message to terminal C to connect an interface B session to terminal C (1320), and receives a CONNECT_RES message from terminal C 130 (1330). If the interface B session is established between terminals B and C, terminal B transfers a SEND_DATA message including data selected by a user of terminal A, to terminal C (1340). Terminal B receives a SEND_DATA_ACK message notifying that transferring of data has been complete, from terminal C (1350).

Thereafter, terminal B transfers a DISCONNECT_REQ message to terminal C to disconnect the interface B session between terminals B and C (1360), and receives a DISCONNECT_RES message notifying that the interface B session has been disconnected, from the terminal C (1370). Terminal B transfers a TRANSFER_RES message representing the result of the data transfer to terminal A (1380).

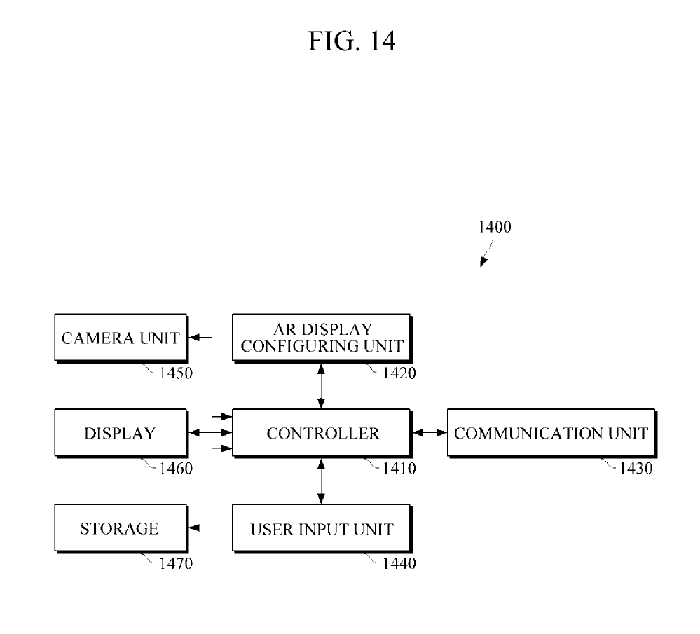

FIG. 14 is a diagram illustrating a data sharing apparatus according to an exemplary embodiment of the present invention.

The data sharing apparatus 1400 may include a controller 1410, an Augmented Reality (AR) display configuring unit 1420, a communication unit 1430, an input unit 1440, a camera unit 1450, a display 1460, and a storage 1470. The data sharing apparatus 1400 may be implemented as any of the terminals A, B or C of FIG. 1.

The data sharing apparatus 1400 may establish, as described above, an interface B session with another terminal for data sharing through a WiFi direct network. Also, the data sharing apparatus 1400 may perform an operation of receiving and transferring data lists and data, as described above, in order to share data with another terminal.

The controller 1410 controls the AR display configuring unit 1420, the communication unit 1430, the user input unit 1440, the camera unit 1450, the display 1460, and the storage 1470 to cause the data sharing apparatus 1400 to establish a local network with another terminal and to share data through the local network.

The AR display configuring unit 1420 configures an AR display by combining a real image with AR information. The AR information may be a user interface that can interact with a user input.

The communication unit 1430 communicates with other terminals (not shown). The communication unit 1430 may establish a WiFi direct network with another terminal, and connects and disconnects the interfaces A and B.

The user input unit 1440 may include various user input devices, such as a touch pad, a touch screen, a keypad, a mouse, or the like. A user input signal input through the user input unit 1440 is transferred to the controller 1410 so that the controller 1410 can perform a reference operation according to the user input signal.

The camera unit 1450 may include an image sensor, such as a lens, a CCD, a CMOS, and an analog digital converter. The camera unit 1450 captures an object to generate an image signal, and transfers the image signal to the controller 1410. The controller 1410 may perform image processing, such as noise cancellation, color correction, etc., on images converted to digital signals.

The display 1460 may encompass various types of displays, such as a color LCD and the like. The display 1460 may display images captured by the camera unit 1450 in an exposure mode under the control of the controller 1460. Also, in an active mode, the display 1460 may receive an AR display from the AR display configuring unit 1420 and display the AR display, wherein the AR display includes images captured by the camera unit 1450 with AR information, such as frame markers, data lists, data types, information about data transmission and reception, and the like.

The storage 1470 stores various information including operating systems (OS), programs, data, communication protocol information, etc. This information may be used for the operation of the data sharing apparatus 1400.

The data sharing apparatus 1400 may operate in an active mode or in a passive mode.

In the active mode, the data sharing apparatus 1440 photographs a first passive-mode terminal (not shown).

The camera unit 1450 photographs an information code, with the information code including connection information used to connect the first passive-mode terminal to a local network, and a frame marker that is used as AR information of the first passive-mode terminal in the local network. As explained above, the frame marker information may correspond to an IP address. The information code may be a QR code.

The AR display configuring unit 1420 creates an AR display using the frame marker or other pertinent information. The AR display is configured by providing an image of the first passive-mode terminal with a graphical representation of the frame marker. The frame marker may be selectable, thus allowing a user to access control of data transmission.

The controller 1410 controls the communication unit 1430 to transfer and receive data to and from the first passive-mode terminal according to a user input to the AR display.

The communication unit 1430 allows communication with the first passive-mode terminal through a local network, and may establish a session for data sharing under the control of the controller 1410.

The controller 1410 may establish a local network using connection information included in an information code of another passive-mode terminal, or may establish a session for data sharing.

The controller 1410 may photograph the first passive-mode terminal to acquire an information code, extract a GOID of a WiFi direct network corresponding to connection information included in the information code, and establish a local network with the first passive-mode terminal using the GOID.

In detail, the controller 1410 compares the extracted GOID to a GOID of the data sharing apparatus 1400, and if the extracted GOID is identical to the GOID of the data sharing apparatus 1400, the controller 1410 establishes a session for data sharing with the first passive-mode terminal through the local network. If the data sharing apparatus 1400 does not have a GOID (indicating it is not part of a local network) and has a SSID, the controller 410 may request the first passive-mode terminal to allow the data sharing apparatus 1400 to connect to the local network using the GOID extracted from the information code.

If the camera unit 1450 photographs an information code of a second passive-mode terminal which is not connected to a local network, the information code including connection information used for connecting to the local network, the controller 1410 may extract a SSID from the information code, and use the SSID for connection information. The controller 1410 requests the second passive-mode terminal to connect to the local network using the SSID, and controls the communication unit 1430 to establish a session for data sharing with the second passive-mode terminal.

The controller 1410 requests data lists included in the first passive-mode terminal through the communication unit 1430, and if receiving the data lists from the first passive-mode terminal, controls the AR display configuring unit 1420 to configure an AR display of the data lists as AR information, the data lists being lists of data associated with the first passive-mode terminal.

The AR display configuring unit 1420 may configure an AR display in which data type information included in the data lists from the first passive-mode terminal is arranged around the frame marker of the first passive-mode terminal. The AR display configuring unit 1420 may configure an AR display in which information about a lower directory belonging to the data types of the data type information arranged around the frame marker corresponding to the first passive-mode terminal is provided to a user, according to a user input signal.

The controller 1410 may transfer a data request message to the first passive-mode terminal through the communication unit 1430, according to a user input signal for selecting data stored in the first passive-mode terminal on the AR display and fetch and receive the selected data to the data sharing apparatus 1400 from the first passive-mode terminal through the communication unit 1430. The AR display configuring unit 1420 may configure an AR display that indicates that the first passive-mode terminal is in the act of transmitting data and the data sharing apparatus 1400 is in the act of receiving the data. The user input signal may be drag-and-drop.

The controller 1410 may transfer data selected according to a user input signal, to the first passive-mode terminal. The user input signal may indicate a selection on an AR display that is configured by the AR display configuring unit 1420, and the selection may instruct the controller 1410 to transmit the selected data to the first passive-mode terminal.

The controller 1410 may operate, as described above, to exchange data and data lists between passive-mode terminals through an interface A session and an interface B session.

In the passive mode, the AR display configuring unit 1420 may configure a passive-mode display on the display 1460 so that an active-mode terminal establishes a session for sharing a local network and data with the data sharing apparatus 1400. If the data sharing apparatus 1400 is already connected to the local network, the AR display configuring unit 1420 configures a passive mode display. The passive mode display may include an information code which contains connection information used for connecting to the local network, and a frame maker, which indicates information for determining an IP address and may be used in generating AR information.

The storage 1470 may store a frame marker table for deciding a frame marker corresponding to an IP address. If the data sharing apparatus 1400 is connected to a WiFi direct network, the controller 1410 is allocated a GOID and an IP address from a group owner of a WiFi direct network and decides a frame marker corresponding to the IP address with reference to the frame marker table, and the AR display configuring unit 1420 may create an information code using the GOID.

If the data sharing apparatus 1400 is not connected to a local network, the AR display configuring unit 1420 may create an information code including a SSID for identifying the data sharing apparatus 1400 to configure a display.

The controller 1410 may control the communication unit 1430 to transfer or receive data to or from an active-mode terminal, in response to a data sharing request from the active-mode terminal.

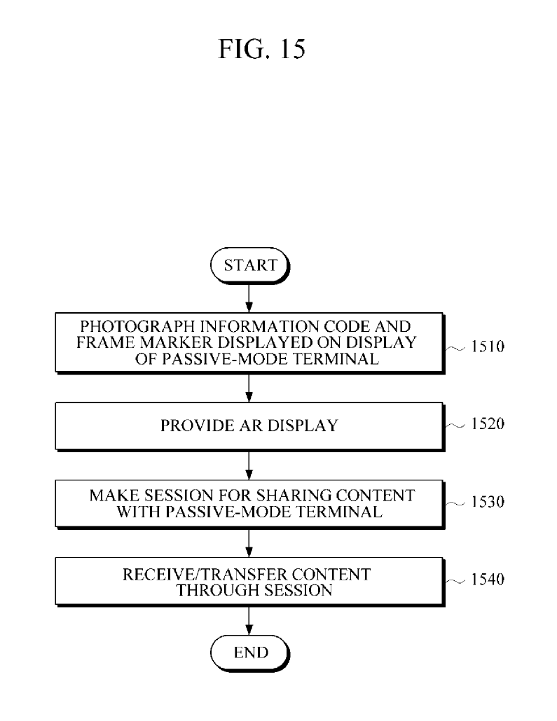

FIG. 15 is a flowchart illustrating a method for sharing data according to an exemplary embodiment of the present invention.

Referring to FIG. 15, a data sharing apparatus photographs an information code and a frame marker of a first passive-mode terminal, wherein the information code includes connection information used for connecting the first passive-mode terminal to a local network, and the frame marker may be used as AR information of the first passive-mode terminal (1510).

The data sharing apparatus 1400 configures an AR display using the frame marker (1520). The AR display is provided to a user through a display. The data sharing apparatus establishes a session for sharing data with the first passive-mode terminal, through a local network established using the connection information (1530). If the local network is a WiFi direct network, the data sharing apparatus may extract a GOID of the WiFi direct network corresponding to the connection information from the information code, and compare the extracted GOID to a GOID of the data sharing apparatus.

If the extracted GOID is identical to the GOID of the data sharing apparatus, the data sharing apparatus may establish a session for sharing data with the first passive-mode terminal through the local network (1530).

If the extracted GOID is not identical to the GOID of the data sharing apparatus, the data sharing apparatus may output a message notifying a user that data sharing is not possible at this time.

The data sharing apparatus transfers and receives data to and from the first passive-mode terminal through the session, according to a user input that is input while operating an AR display (1540).

If the data sharing apparatus photographs a second passive-mode terminal not connected to the local network, the data sharing apparatus may acquire an information code including connection information used for connecting to a local network, from the photographed image of the second passive-mode terminal. In this case, the data sharing apparatus may extract a SSID corresponding to the connection information from the information code of the second passive-mode terminal, and request the second passive-mode terminal connects to the local network using the extracted SSID. If the second passive-mode terminal is connected to the local network, the data sharing apparatus 1400 may establish a session for sharing data with the second passive-mode terminal, and receive and transfer data and data lists to and from the second passive-mode terminal.

In the following various descriptions, the active-mode terminal may be terminal A of FIG. 1, a first passive-mode terminal may be terminal B of FIG. 1, and a second passive-mode terminal may be terminal C of FIG. 1. The terminals A, B, and C are members belonging to the same WiFi direct network, a frame marker of the terminal A is “1”, a frame marker of the terminal 120 is “2”, and a frame marker of the terminal C is “3”.

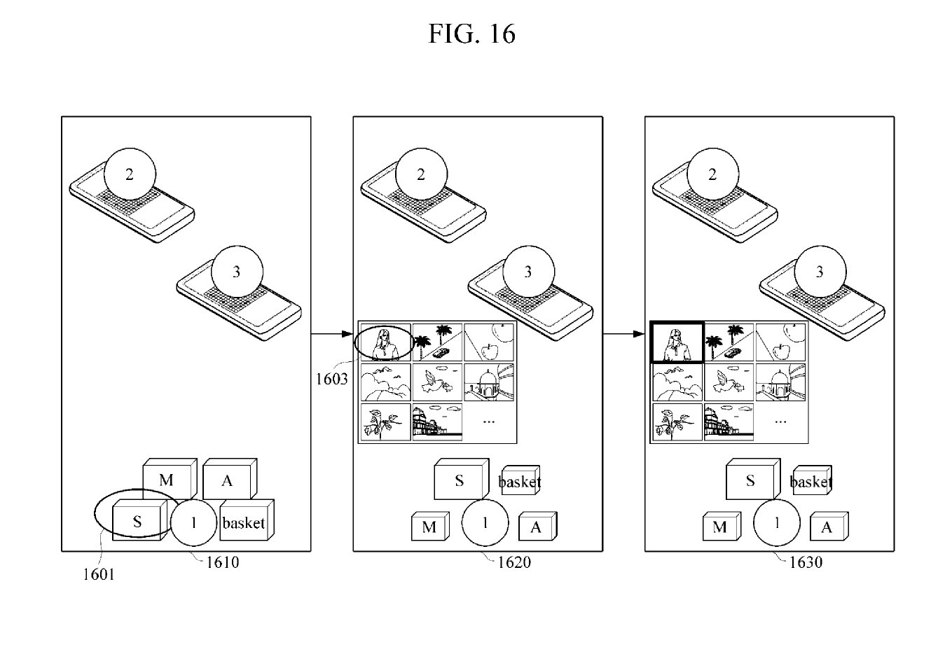

FIG. 16 illustrates Augmented Reality (AR) displays according to an exemplary embodiment of the present invention.

The active-mode terminal A photographs the terminals B and C. In more detail, the terminal A photographs a QR code and a frame marker that are displayed on a display of terminal B, and a QR code and a frame marker that are displayed on a display of the terminal C.

Terminal A displays its own frame marker “1”, displays the frame marker “2” of terminal B while displaying it along with an image of terminal B, and displays the frame marker “3” of terminal C while displaying it along with an image of terminal C, thereby configuring and displaying an AR display 1610. Also, as shown on an AR display 1610, terminal A may display a data type, such as “S (Still image)”, “M (Moving image)”, “A (Audio)”, etc., around the frame marker “1”. Also, terminal A may display a folder “basket”, which stores data to be shared, together with the various icons for different data types. AR information, such as the frame marker, the data type information, and the folder “basket”, may serve as a user interface that allows operation of the apparatus according to a user input.

If the user selects a “S” region 1601 on the display 1610, a lower directory of the “S” region may be displayed, as illustrated in display 1620. Also, if the user selects one item 1603, a display 1630 through which the user can recognize item 1603 may be displayed.

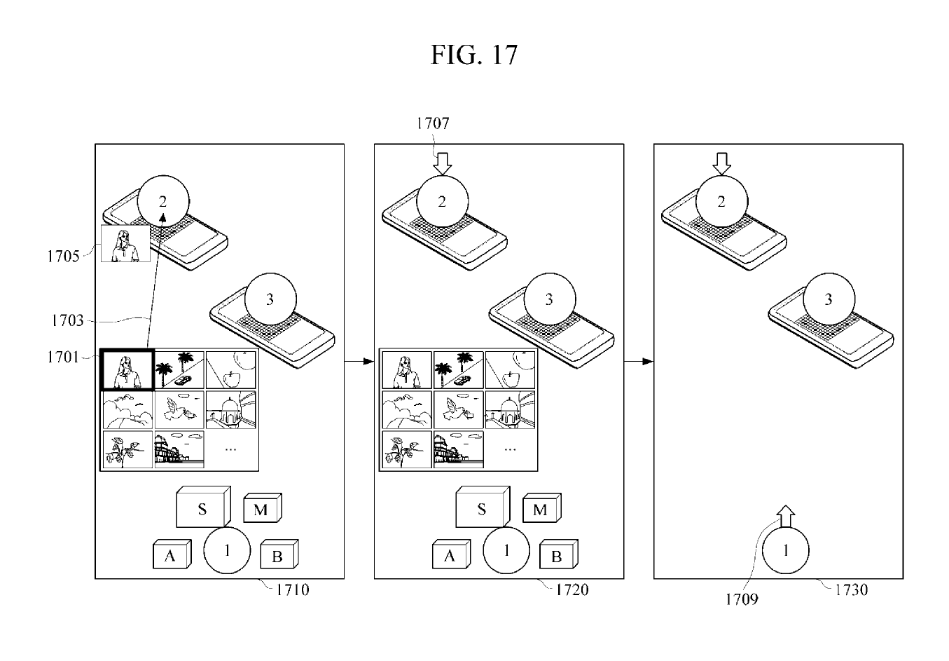

FIG. 17 illustrates Augmented Reality (AR) displays according to an exemplary embodiment of the present invention.

As illustrated in a display 1710, if a user of terminal A selects data 1701 and drags the data 1701 to a terminal corresponding to a frame marker “2” in an arrow direction 1703, AR information 1705 representing that the data 1701 will be transferred to terminal B may be displayed. This action may also start a transferring of the data 1701 to terminal B.

If the user drops the dragged data 1701 on terminal B to which the frame marker “2” is attached, a display 1720 on which an arrow 1707 indicating that data is being received to the terminal B corresponding to the frame marker “2” is provided.

If the user selects a region corresponding to a frame marker “1”, data types and data lists stored in terminal A may be hidden, and as illustrated in display 1730, an arrow 1709 is added to the frame marker “1” to represent that data is being transmitted from terminal A. The arrows 1707 and 1709 may disappear if the data transfer has finished.

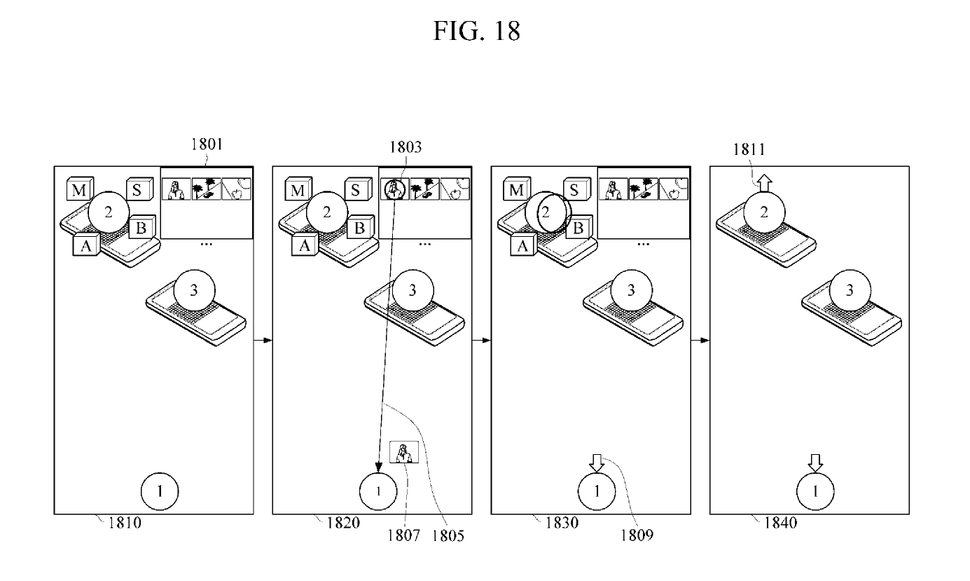

FIG. 18 illustrates Augmented Reality (AR) displays according to an exemplary embodiment of the present invention.

If a user selects a region corresponding to the frame marker “2” on the display 1610 of FIG. 16, terminal A may request data lists of terminal B corresponding to the frame marker “2”, and receive the data lists of terminal B from terminal B.

Terminal A may provide a display 1810 displaying information regarding data types, such as ‘S’, ‘M’, ‘A’, etc., included in the data lists of terminal B, around the frame marker “2”, and display thumbnail information included in the data lists, like AR information 1801.

As illustrated in display 1820, if a user of terminal A drags data 1803 of terminal B to terminal A corresponding to a frame marker “1” in the direction of an arrow 1805, AR information 1807 representing that the data 1803 will be transferred to the terminal B may be displayed.

If the user drops the data 1803 on a region of terminal A corresponding to the frame marker “1”, a display 1830 including an arrow 1809 representing that data is being received to the terminal A corresponding to the frame marker “1” may be provided.

If the user selects a region corresponding to the frame marker “2”, data types and data lists of terminal B are hidden, and like the display 1830, an arrow 1811 is added to the frame marker “2” to represent that data is being transferred from terminal B. The arrows 1809 and 1811 may disappear if the data transfer finishes.

The present invention can be implemented as non-transitory computer readable codes in a computer readable record medium. The computer readable record medium includes all types of record media in which computer readable data are stored. Examples of the computer readable record medium include a ROM, a RAM, a CD-ROM, a magnetic tape, a floppy disk, and an optical data storage. Further, the record medium may be implemented in the form of a carrier wave such as Internet transmission. In addition, the computer readable record medium may be distributed to computer systems over a network, in which computer readable codes may be stored and executed in a distributed manner.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A first terminal to provide augmented reality (AR) to share data, comprising:
an image acquiring unit to acquire an image of a second terminal;
a controller to control the first terminal and to acquire network information from the image of the second terminal;
an AR configuration unit to create an AR display based on the image of the second terminal and the acquired network information; and
a communication unit to communicate data between the first terminal and the second terminal via a network,
wherein the communication unit communicates data selected via the AR display.

2. The first terminal according to claim 1, wherein the network corresponds to the network information.

3. The first terminal according to claim 2, wherein the network is a WiFi direct network.

4. The first terminal according to claim 3, wherein the first terminal and the second terminal are members of the WiFi direct network, and
the communication unit establishes a connection between the first terminal and the second terminal.

5. The first terminal according to claim 3, wherein the first terminal is a member of the WiFi direct network and the second terminal is not a member of the WiFi direct network, and
the communication unit communicates an invitation to the WiFi direct network to the second terminal.

6. The first terminal according to claim 3, wherein the first terminal is not a member of the WiFi direct network and the second terminal is a member of the WiFi direct network,
the communication network communicates a visit request to the WiFi direct network to the second terminal.

7. The first terminal according to claim 3, wherein the first terminal is a member of the WiFi direct network and the second terminal is a member of a second WiFi direct network, and
the first terminal notifies a user that communication is not possible.

8. The first terminal according to claim 1, wherein the image comprises a quick response (QR) code that contains a group owner identification (GOID) or service set identification (SSID), and a frame marker.

9. The first terminal according to claim 8, wherein the AR display comprises the image of the second terminal and the frame marker of the second terminal, and
the AR display allows a user to select a file from the first terminal and the second terminal to be shared there between.

10. The first terminal according to claim 9, wherein the AR display comprises a status icon to indicate communication between the first terminal and the second terminal.

11. A method for sharing data via augmented reality (AR) on a first terminal, comprising:
acquiring an image of a second terminal;
acquiring network information of a network from the image of the second terminal;
creating an AR display based on the image of the second terminal and the acquired network information;
allowing a selection of data based on the AR display; and
communicating the selected data between the terminal and the second terminal via the network.

12. The method according to claim 11, wherein the network is a WiFi direct network.

13. The method according to claim 12, further comprising:
establishing a connection with the first terminal and the second terminal,
wherein the first terminal and the second terminal are members of the WiFi direct network.

14. The method according to claim 12, wherein if the first terminal is a member of the WiFi direct network and the second terminal is not a member of the WiFi direct network, communicating an invitation to the second terminal.

15. The method according to claim 12, wherein if the first terminal is not a member of the WiFi direct network and the second terminal is a member of the WiFi direct network, communicating a visit request to the second terminal.

16. The method according to claim 12, wherein if the first terminal is a member of the WiFi direct network and the second terminal is a member of a second WiFi direct network, notifying a user that communication is not possible.

17. The method according to claim 11, wherein the image comprises a quick response (QR) code that contains group owner identification (GOID) or service set identification (SSID), and a frame marker.

18. The method according to claim 17, further comprising:
allowing a user to select a file from the first terminal and the second terminal to share with each other, wherein the AR display comprises the image of the second terminal and the frame marker of the second terminal.

19. The method according to claim 18, wherein the AR display comprises a status icon to indicate communication between the first terminal and the second terminal.

20. A passive-mode terminal, comprising:
a display unit to display an image comprising network information;
a quick response (QR) code generating unit to generate a QR code to identify the terminal;
a frame marker generating unit to generate a frame marker of a WiFi direct network to which the terminal is a member; and
a communication unit to communicate data between the passive-mode terminal and an active-mode terminal via a network,
wherein the network corresponds to the WiFi direct network or a WiFi direct network to which the active-mode terminal is a member.

21. The terminal according to claim 20, wherein the QR code and frame marker code contain a group owner identification (GOID) or service set identification (SSID).
